(19) United States
(12) Patent Application Publication
(10) Pub. No.: US 2012/0088426 A1
(43) Pub. Date: Apr. 12, 2012

(54) Method of manufacturing LCDs from half-finished LCD articles

(76) Inventor: Rong Ji Ro, Taipei (TW)

(21) Appl. No.: 12/900,483

(22) Filed: Oct. 8, 2010

(51) Int. Cl. H01J 9/00

(52) U.S. Cl. 445/24

(57) ABSTRACT

A method of manufacturing an LCD from a rectangular half-finished LCD article including a first polarizing filter film on one surface, a first glass substrate adhered to the first polarizing filter film, a second polarizing filter film on the other surface, a second glass substrate adhered to the second polarizing filter film, and a twisted nematic liquid crystal layer between the first and second glass substrates comprising the steps of cutting the first polarizing filter film; turning the half-finished LCD article upside down; cutting the second polarizing filter film; cutting the first glass substrate; turning the half-finished LCD article upside down; cutting the second glass substrate; removing the cut portions of both the first and second glass substrates; and applying UV light curing adhesive on periphery of each of the second glass substrate and the twisted nematic liquid crystal layer to produce the finished LCD.

### BACKGROUND OF THE INVENTION

1. Field of Invention

The invention relates to the manufacturing of LCDs (liquid crystal displays) and more particularly to a method of manufacturing LCDs from half-finished LCD articles with improved characteristics.

2. Description of Related Art

Typically, LCDs are manufactured in predetermined sizes for the sake of mass production. However, they may be not suitable for specific applications such as military equipment, public transportation vehicles, etc. Thus, how to cut half-finished LCD articles into desired shapes and sizes is a critical issue to be addressed. The present invention disclosed below is directed to such a method of manufacturing LCDs from half-finished LCD articles.

### SUMMARY OF THE INVENTION

It is therefore one object of the invention to provide a method of manufacturing an LCD from a substantially rectangular half-finished LCD article including a first polarizing filter film on one surface, a first glass substrate adhered to the first polarizing filter film, a second polarizing filter film on the other surface, a second glass substrate adhered to the second polarizing filter film, and a twisted nematic liquid crystal layer sandwiched between the first and second glass substrates, the method comprising the steps of cutting the first polarizing filter film; turning the half-finished LCD article upside down; cutting the second polarizing filter film; cutting the first glass substrate; turning the half-finished LCD article upside down; cutting the second glass substrate; removing the cut portions of both the first and second glass substrates; and applying ultraviolet (UV) light curing adhesive on a periphery of each of the second glass substrate and the twisted nematic liquid crystal layer to produce the finished LCD.

The above and other objects, features and advantages of the invention will become apparent from the following detailed description taken with the accompanying drawings.

### BRIEF DESCRIPTION OF THE DRAWINGS

FIG. 1 is a perspective view of a half-finished LCD article according to the invention;

FIG. 2 is a side view of the half-finished LCD article;

FIG. 3 illustrates step 1 of a method of manufacturing an LCD from the half-finished LCD article according to the invention;

FIGS. 4 to 10 illustrate steps 2 to 8 of the method respectively; and

FIGS. 11 to 14 are longitudinal sectional view, perspective view from the rear, rear view, and perspective view from the front of the finished LCD respectively.

### DETAILED DESCRIPTION OF THE INVENTION

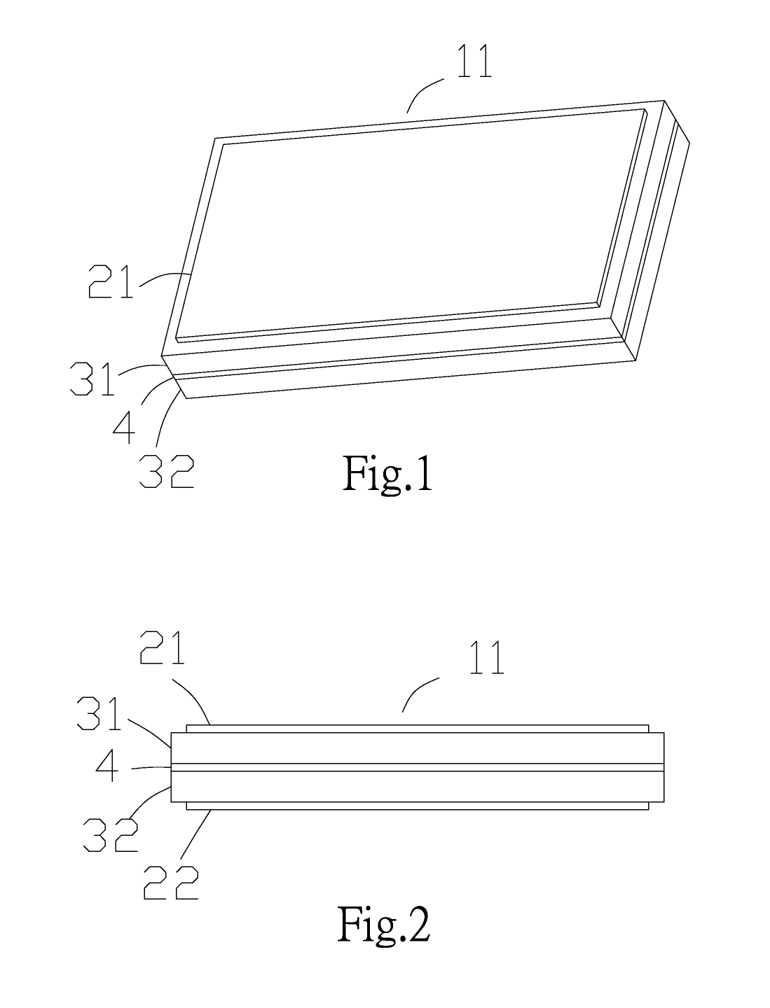

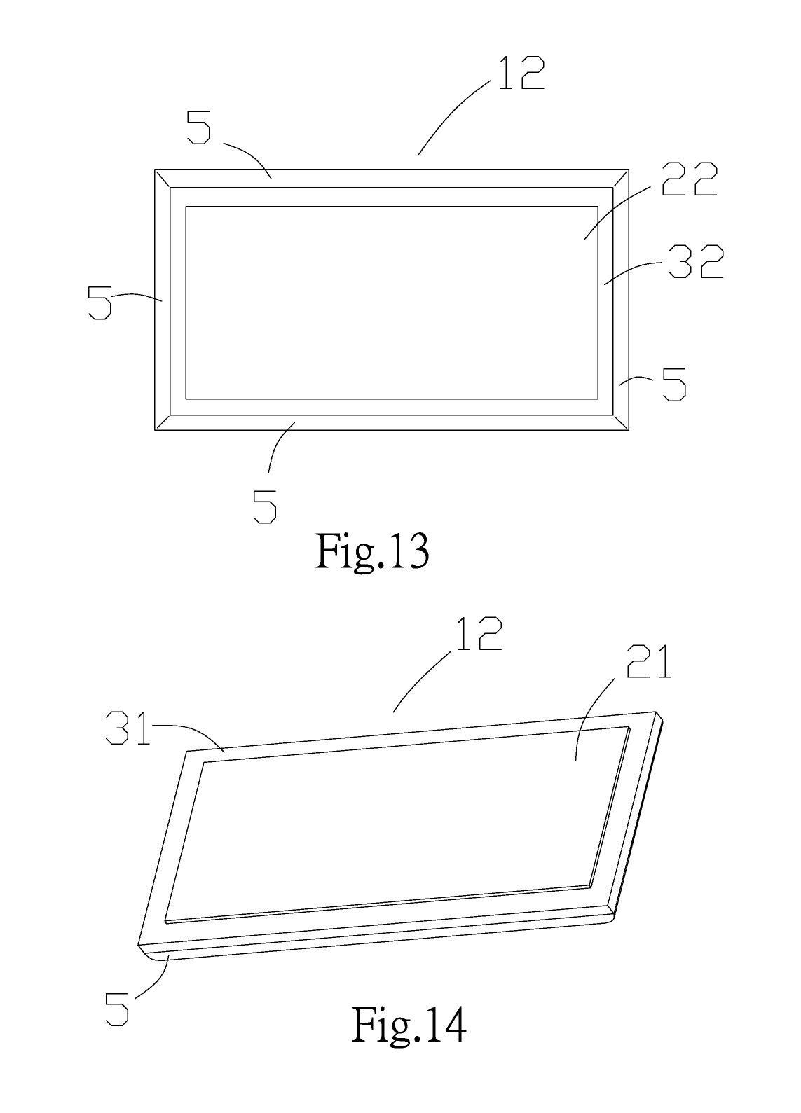

Referring to FIGS. 1 to 14, a method in accordance with the invention is illustrated below.

As shown in FIGS. 1 and 2 specifically, a substantially thick, rectangular half-finished LCD article 11 comprises a first polarizing filter film 21 on one surface, a second polarizing filter film 22 on the other opposite surface, a first glass substrate 31 below the first polarizing filter film 21, a second glass substrate 32 on the second polarizing filter film 22, and a twisted nematic liquid crystal layer 4 sandwiched between the first glass substrate 31 and the second glass substrate 32.

The method of manufacturing an LCD from a half-finished LCD article (e.g., the half-finished LCD article 11) comprises the following steps:

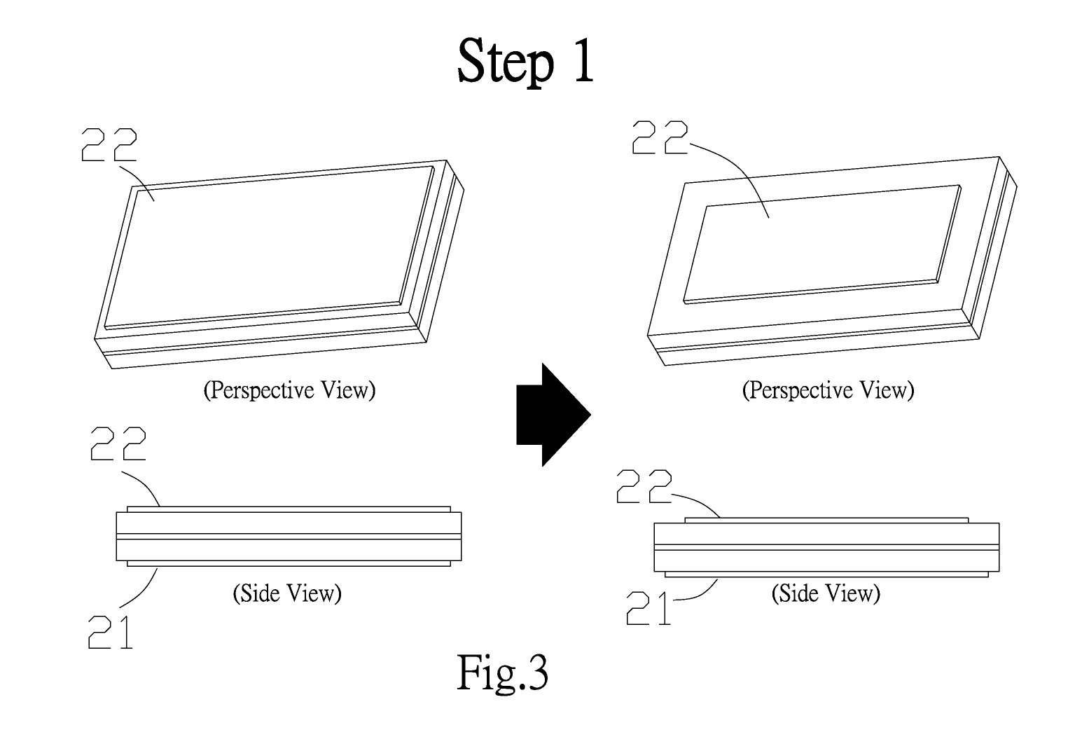

Step 1: As shown in FIG. 3 specifically, cutting the second polarizing filter film 22 on the other surface of the half-finished LCD article to a desired size.

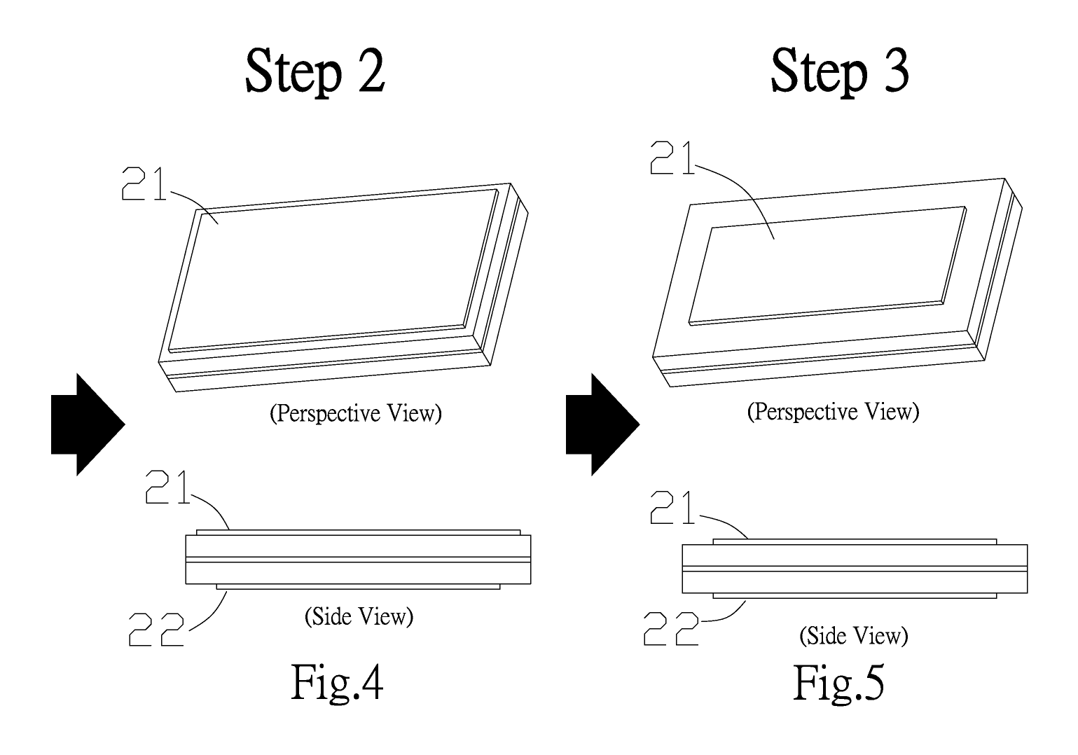

Step 2: As shown in FIG. 4 specifically, turning the half-finished LCD article upside down.

Step 3: As shown in FIG. 5 specifically, cutting the first polarizing filter film 21 on one surface of the half-finished LCD article to a desired size.

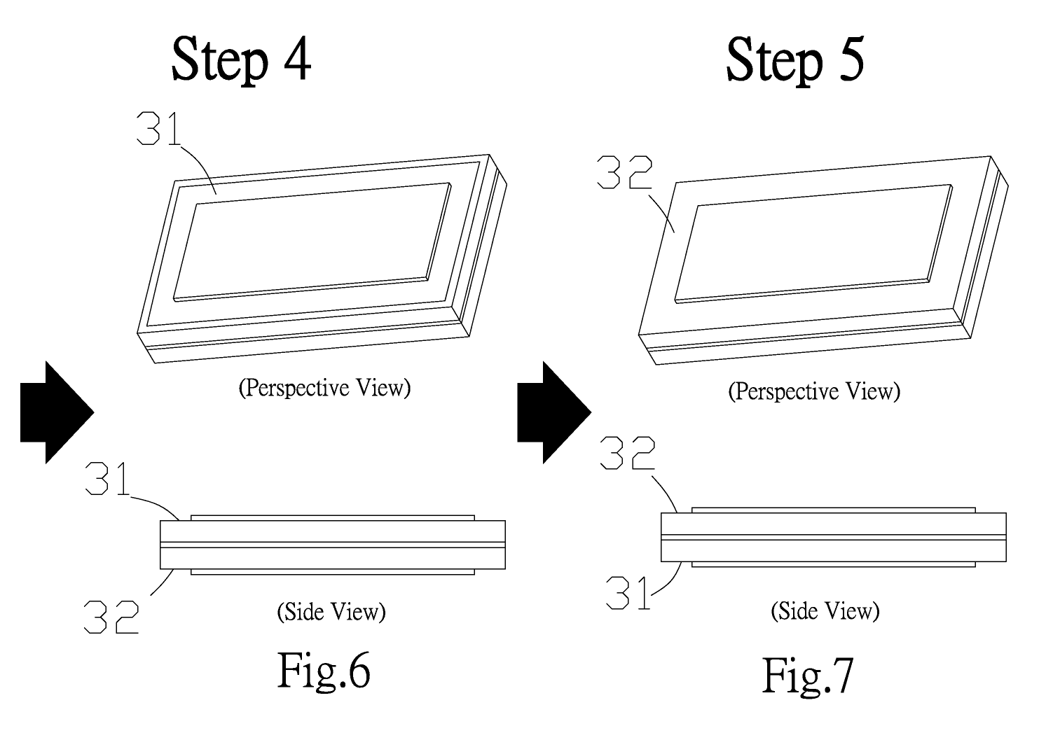

Step 4: As shown in FIG. 6 specifically, cutting the first glass substrate 31 of the half-finished LCD article to a desired size.

Step 5: As shown in FIG. 7 specifically, turning the half-finished LCD article upside down.

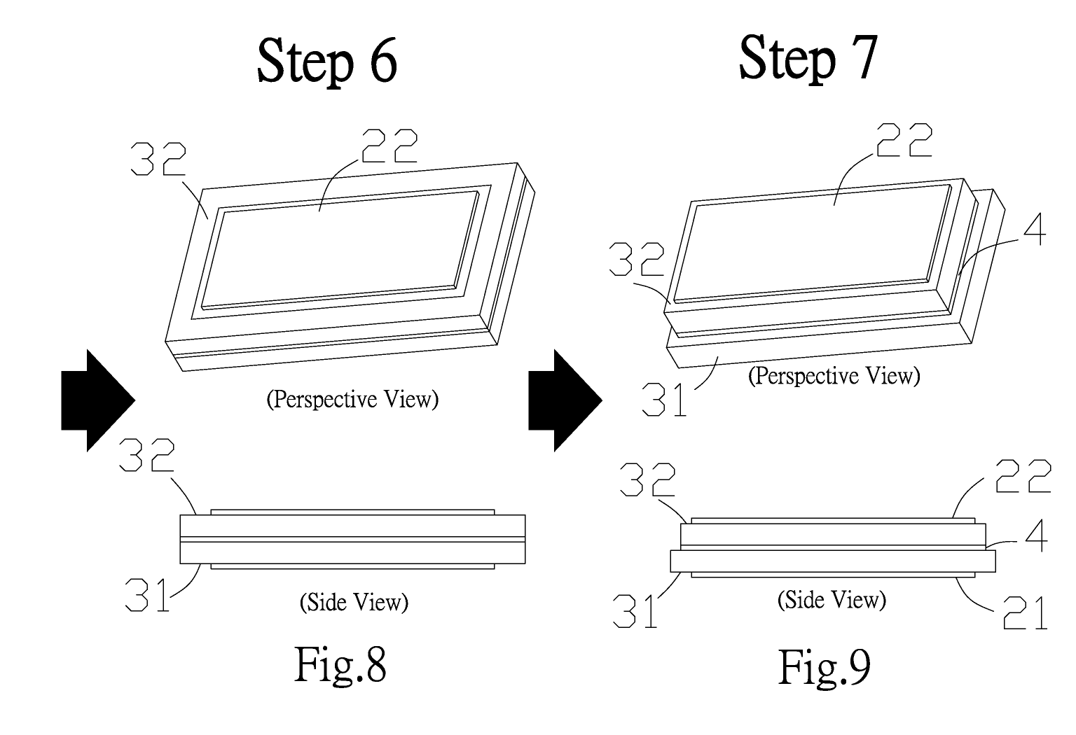

Step 6: As shown in FIG. 8 specifically, cutting the second glass substrate 32 of the half-finished LCD article to a desired size.

Step 7: As shown in FIG. 9 specifically, removing the cut portions of both the first and second glass substrates 31, 32 of the half-finished LCD article. The size of the second glass substrate 32 is smaller than that of the first glass substrate 31 after the removal.

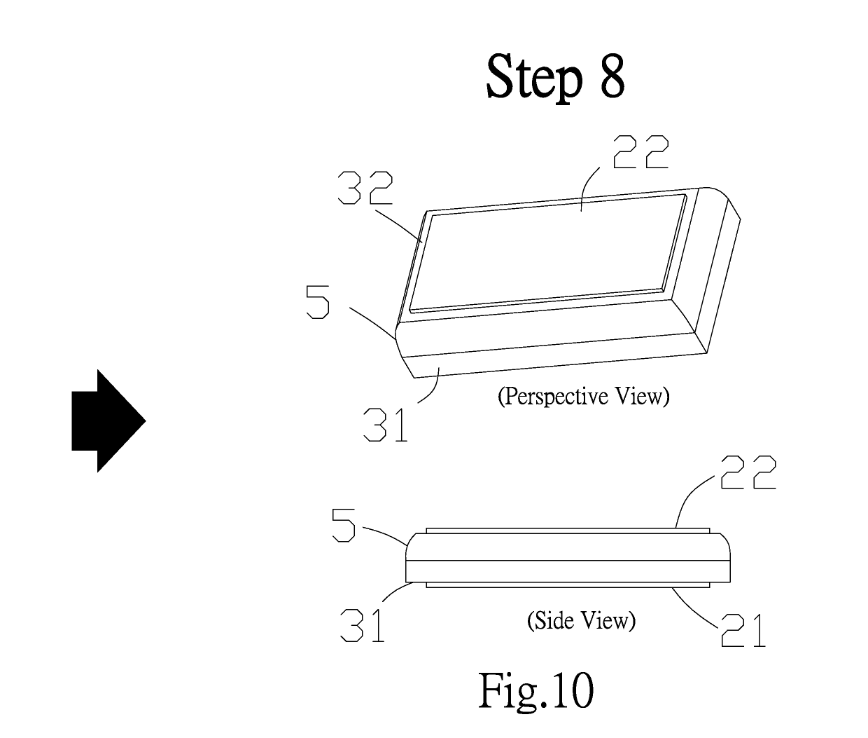

Step 8: As shown in FIG. 10 specifically, applying ultraviolet (UV) light curing adhesive 5 on the periphery of each of the second glass substrate 32 and the twisted nematic liquid crystal layer for finishing.

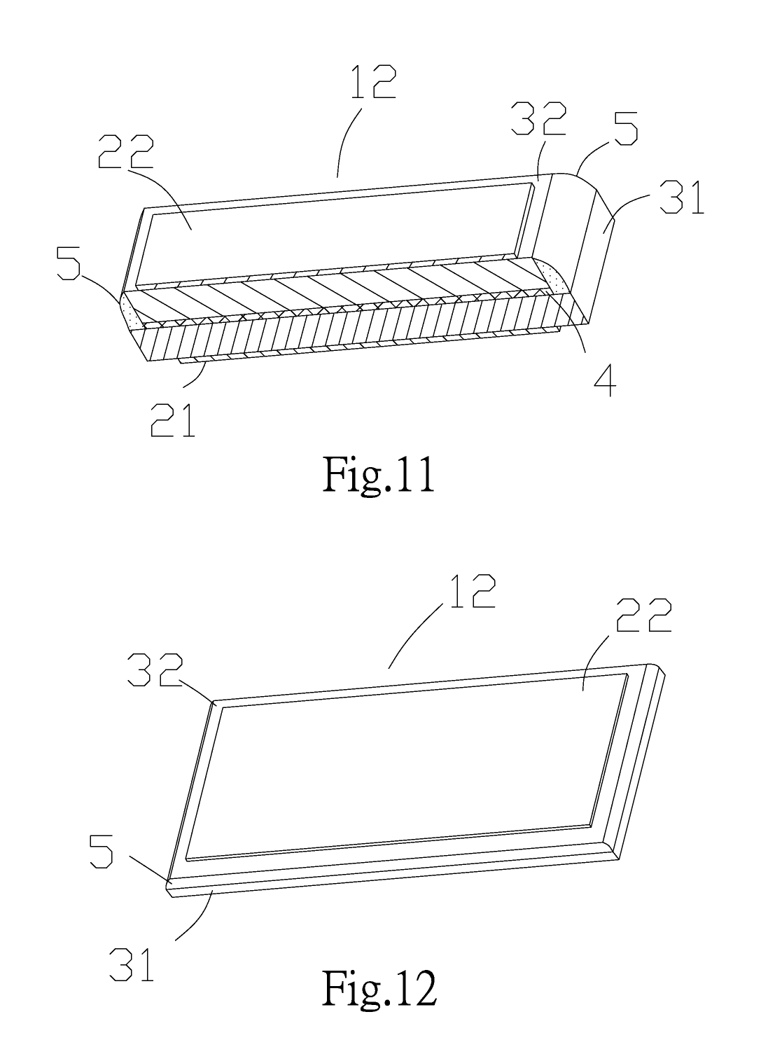

A longitudinal sectional view, a perspective view from the rear, a rear view, and a perspective view from the front of a finished LCD 12 are shown in FIGS. 11 to 14 respectively.

While the invention has been described in terms of preferred embodiments, those skilled in the art will recognize that the invention can be practiced with modifications within the spirit and scope of the appended claims.

1.
A method of manufacturing an LCD from a substantially rectangular half-finished LCD article including a first polarizing filter film on one surface, a first glass substrate adhered to the first polarizing filter film, a second polarizing filter film on the other surface, a second glass substrate adhered to the second polarizing filter film, and a twisted nematic liquid crystal layer sandwiched between the first and second glass substrates, the method comprising the steps of:
cutting the first polarizing filter film;
turning the half-finished LCD article upside down;
cutting the second polarizing filter film;
cutting the first glass substrate;
turning the half-finished LCD article upside down;
cutting the second glass substrate;
removing the cut portions of both the first and second glass substrates; and
applying ultraviolet (UV) light curing adhesive on a periphery of each of the second glass substrate and the twisted nematic liquid crystal layer to produce the finished LCD.

2. (canceled)
